(19) United States
(12) Patent Application Publication
(10) Pub. No.: US 2018/0170744 A1
(43) Pub. Date: Jun. 21, 2018

(54) Personal Water Dispenser

(71) Applicants: Robert Andrew Petersen, Rye, NY (US); Sue Fullerton Eilers, Mamaroneck, NY (US)

(72) Inventors: Robert Andrew Petersen, Rye, NY (US); Sue Fullerton Eilers, Mamaroneck, NY (US)

(21) Appl. No.: 15/385,201

(22) Filed: Dec. 20, 2016

(51) Int. Cl. B67D 1/08; B67D 1/00; G05D 7/06; F25B 21/02

(52) U.S. Cl. CPC B67D 1/0869; B67D 1/0004; B67D 1/0888; F25B 2321/0251; F25B 21/02; B67D 2001/0093; B67D 2210/0001; G05D 7/0617

(57) ABSTRACT

This invention is for a dispenser of cooled water or other beverage in a size and construction suitable for single-person use in locations such as a dorm, hospital, or motel room, where cooled water is desirable but often not at hand. This cooler consists of an insulating shell in the shape of a rectangular prism and comprises various internal off-the-shelf components, including a Peltier chip for cooling and a Kent valve for secure insertion of water, combined for the purpose of dispensing a clean, cooled beverage.

### CROSS-REFERENCE TO RELATED APPLICATIONS

This application claims the benefit of U.S. Provisional Application No. 62/281,095, filed Jan. 20, 2016.

### STATEMENT REGARDING FEDERALLY SPONSORED RESEARCH OR DEVELOPMENT

Not Applicable.

### REFERENCE TO SEQUENCE LISTING, A TABLE, OR A COMPUTER PROGRAM LISTING COMPACT DISC APPENDIX

Not Applicable.

### BACKGROUND OF THE INVENTION

Drinking water is healthful for all of us. This device would enable an individual to have a ready source of clean, cold water near at hand by simply filling a bottle, or reservoir, waiting a few minutes, and dispensing it to a receptacle. This personal water dispenser would be useful in locations where refrigeration is minimal or absent such as a dorm or hospital room. This device would also support delivery of other cooled liquids.

### BRIEF SUMMARY OF THE INVENTION

The purpose of this invention is to deliver cooled water in a convenient location. The device size is dependent on the size of the reservoir: for the prototype, accommodating a quart-size reservoir, it was made approximately thirteen inches high by nine inches wide by thirteen inches long. This size fits easily on a desk or table. Two devices are of primary importance in this invention: a Peltier heat pump (chip), and a Kent shut-off valve. A Peltier heat pump may be used to cool or to heat electronically; in this device it is used for cooling. The Kent shut-off valve is used to provide a method to take a leak-proof container and connect it through the valve so that it permits fluid flow. Here it is used to remove and re-insert the reservoir of liquid to be dispensed.

### BRIEF DESCRIPTION OF THE SEVERAL VIEWS OF THE DRAWINGS

There are four configurations shown in this document which differ in the external location of the door for input of the reservoir and the spout and photoelectric eye for delivery to a receptacle. The interior of the device is slightly altered to accommodate its external configuration. One embodiment shows the door at one end (short side) of the device and the spout at the opposite end. The second one shows the door on the longer side that contains the thermostat but the spout still at one end. The third shows both the door and the spout on the long side that contains the thermostat. The fourth shows a configuration with a permanently installed reservoir with the door on the top above that reservoir.

### BRIEF DESCRIPTION OF THE DRAWINGS

The design and operation of this invention will become more evident after the explanation of the enclosed drawings.

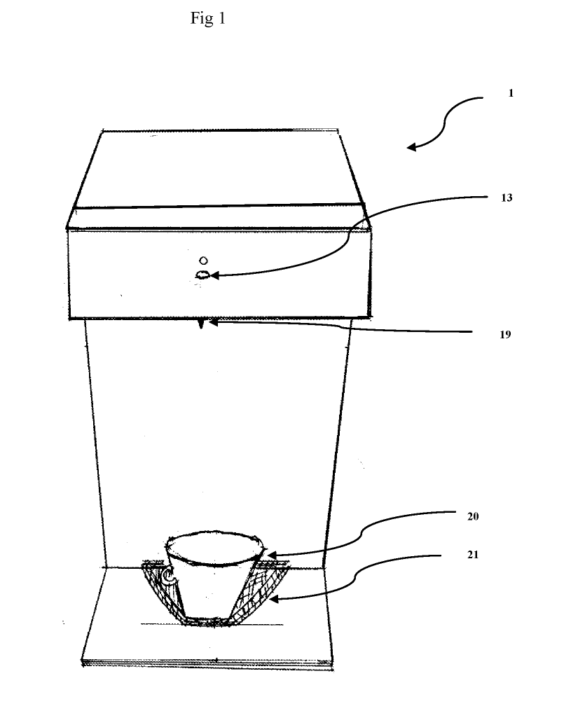

FIG. 1 A view of the end (short side) of the dispenser (configuration A1) showing the location of the photoelectric control, the spout, and the receptacle and splash tray.

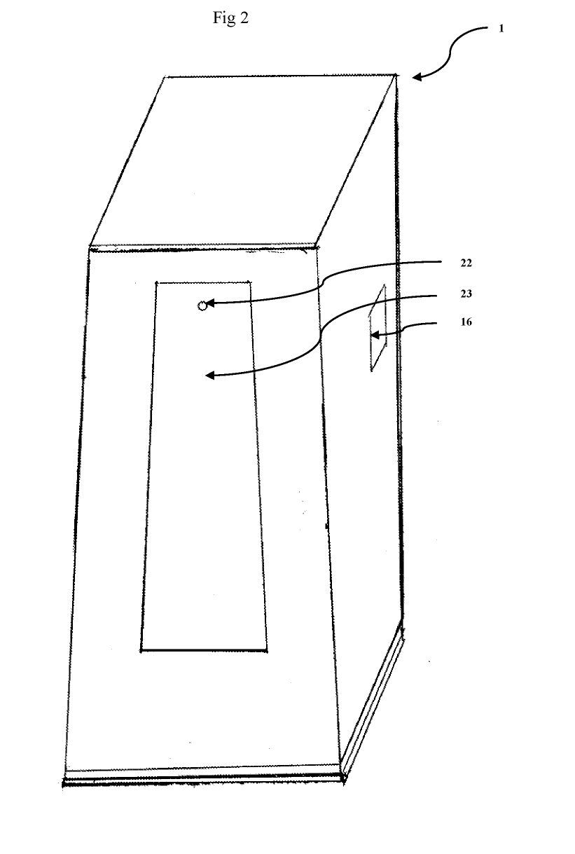

FIG. 2 Shows the opposite end of the dispenser with the door for input of the reservoir.

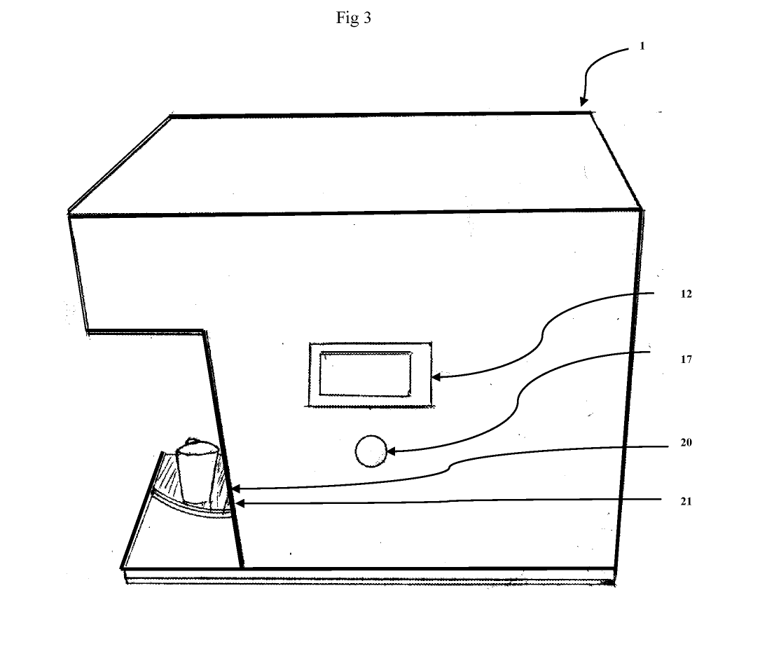

FIG. 3 Depicts the long side of the dispenser containing the thermostat and the on/off switch.

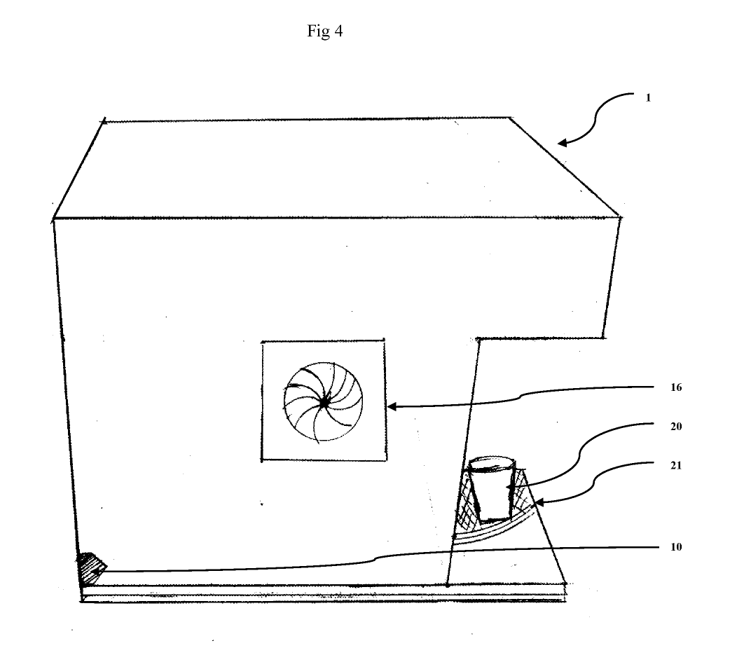

FIG. 4 A view of the fourth side of the dispenser showing the cooling fan.

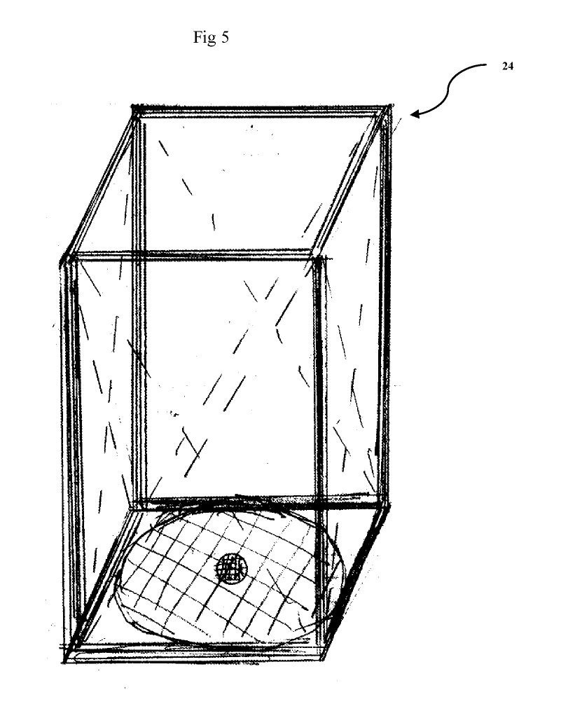

FIG. 5 Shows the cage to hold the reservoir.

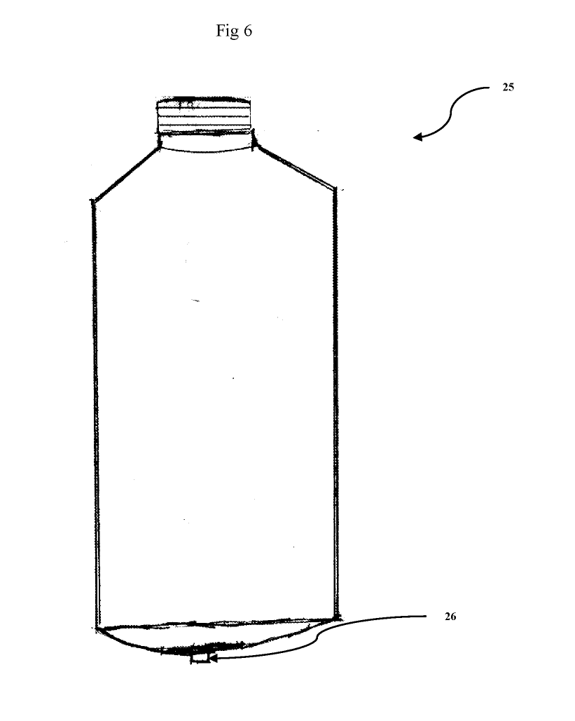

FIG. 6 Depicts the reservoir that goes inside the cage.

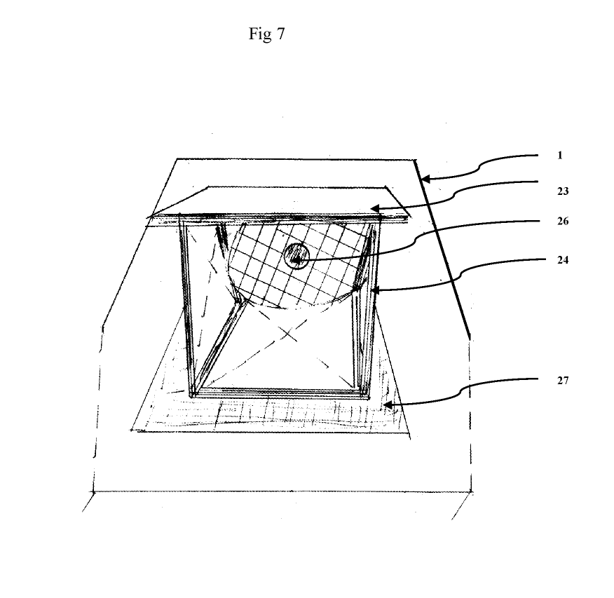

FIG. 7 Shows the cage as it is appears attached to the inside of the door.

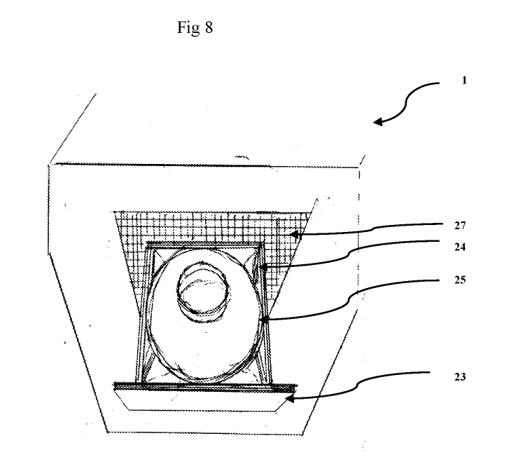

FIG. 8 A view of the cage with the reservoir inserted into the cage.

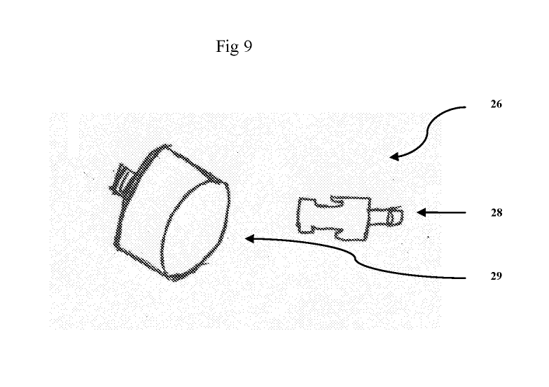

FIG. 9 A view of the Kent shut-off valve (U.S. Pat. No. 6,082,399) used to couple the reservoir and the plastic tubing moving the water in the dispenser.

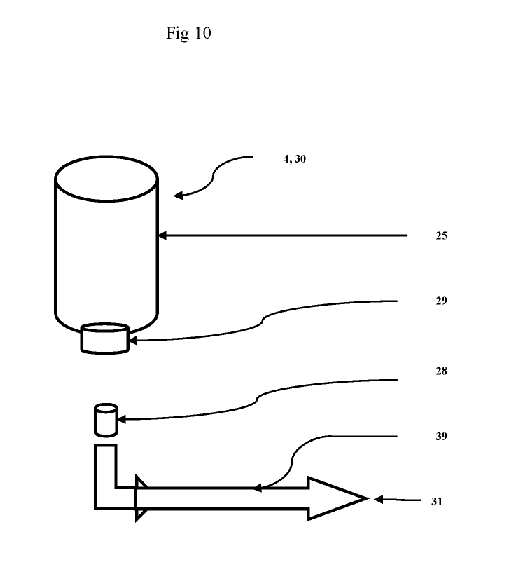

FIG. 10 Shows the water flow in the water dispenser (Part A)

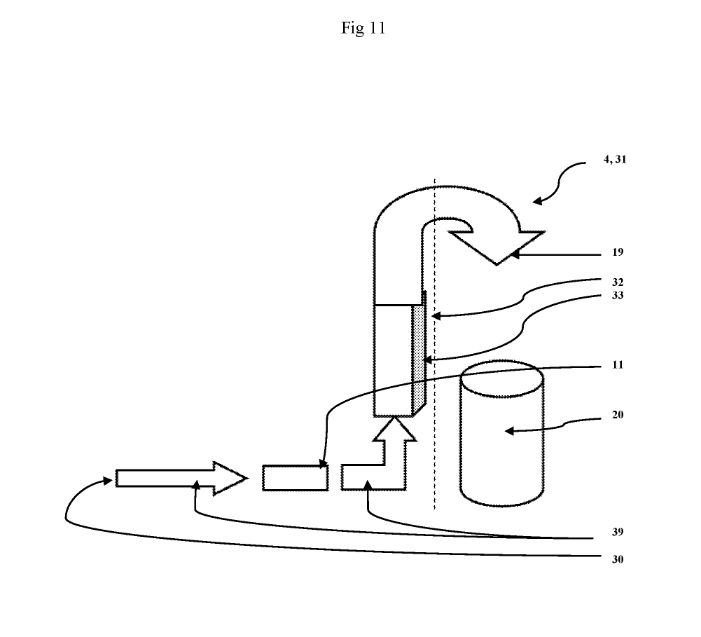

FIG. 11 Shows the water flow in the water dispenser (Part B)

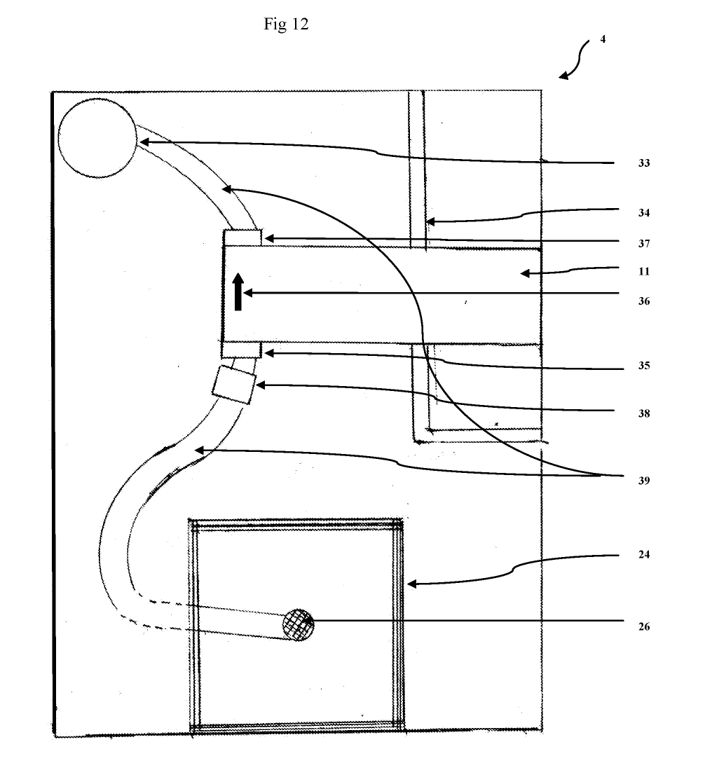

FIG. 12 Depicts the breadboard-like area on the base of the dispenser, where the water is sent from the reservoir through the pump and filter to the spout.

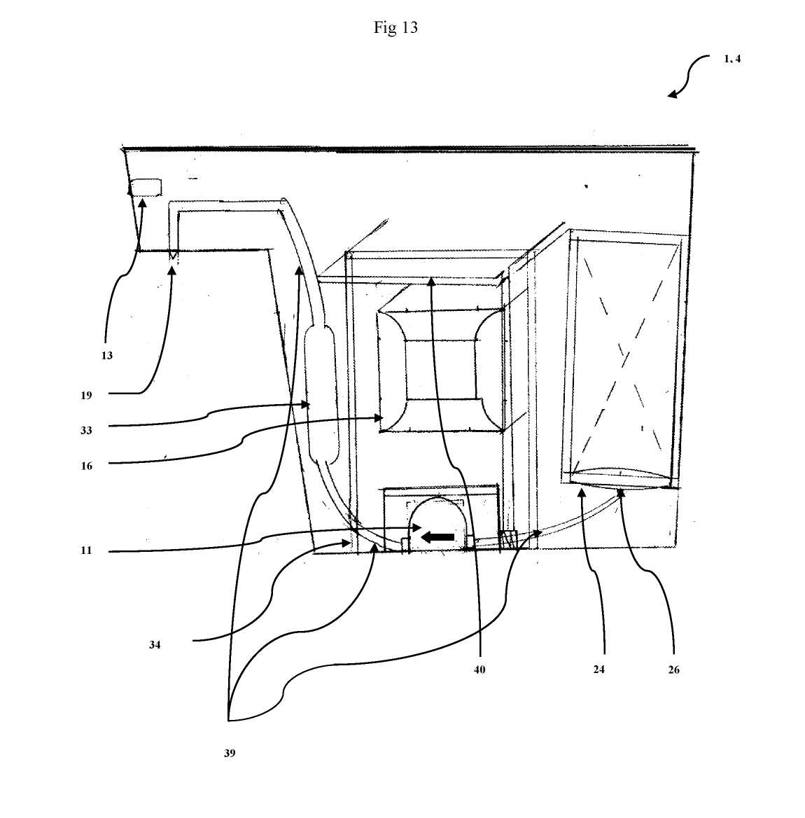

FIG. 13 Internal view of the dispenser with the spout on the left and the door on the right.

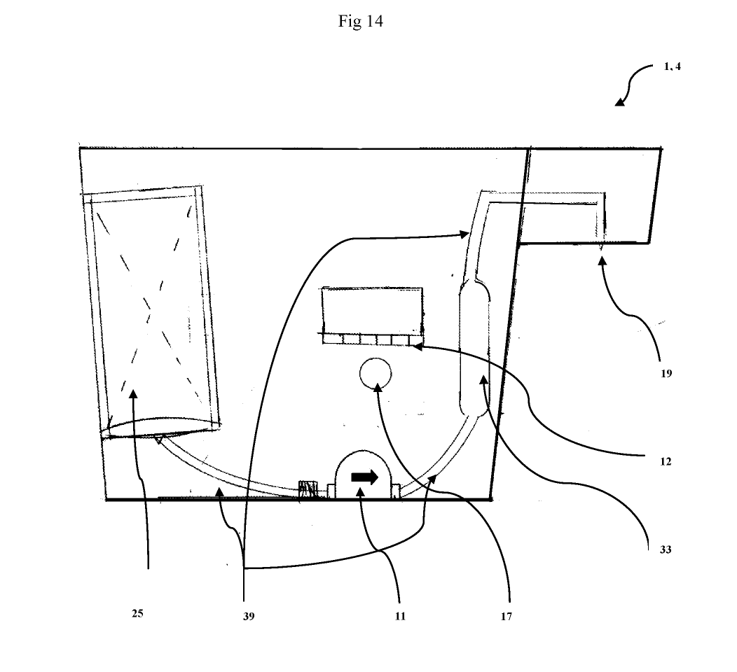

FIG. 14 Internal view of the dispenser with the door on the left and the spout on the right.

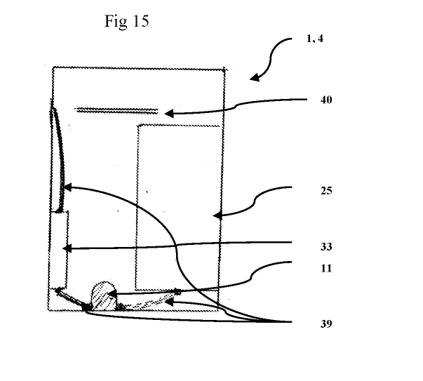

FIG. 15 Internal view of the dispenser showing location of water devices with door on the right and spout on the left.

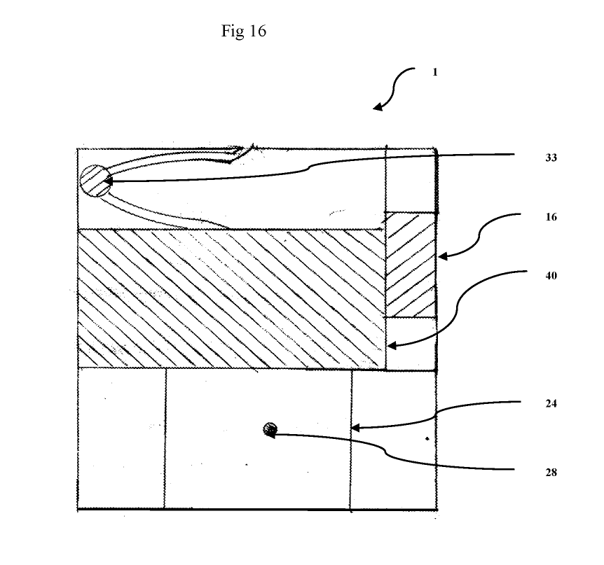

FIG. 16 Top view of the dispenser showing the location of the platform for the wiring controls.

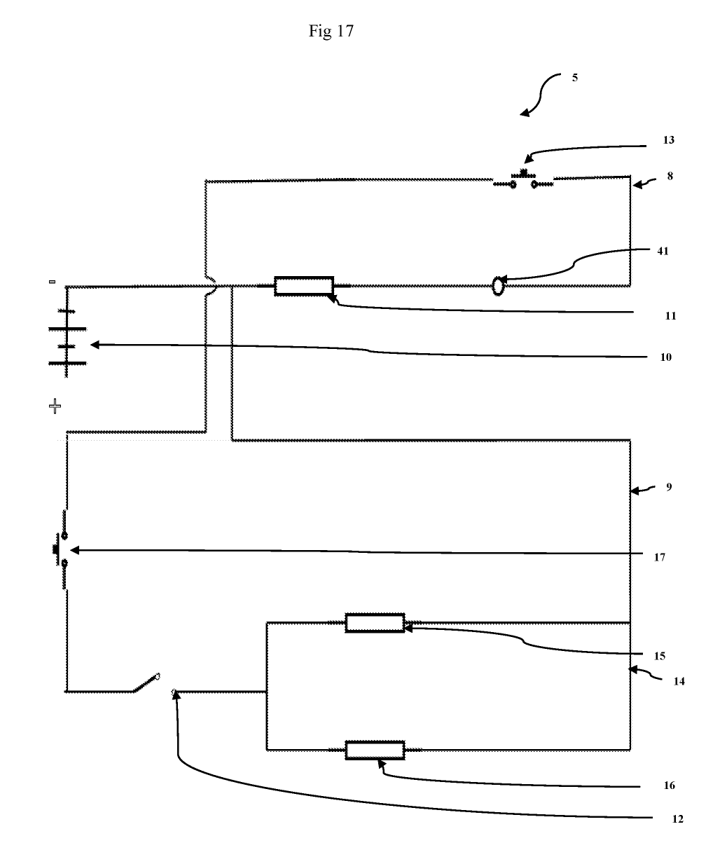

FIG. 17 Wiring diagram of dispenser.

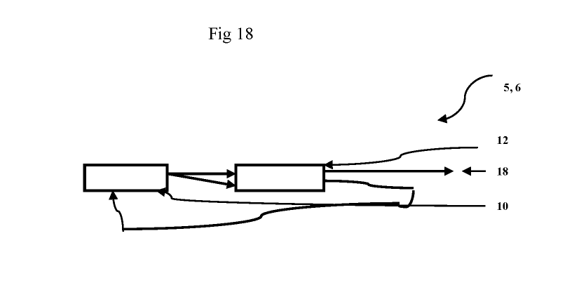

FIG. 18 Wiring diagram of thermostat.

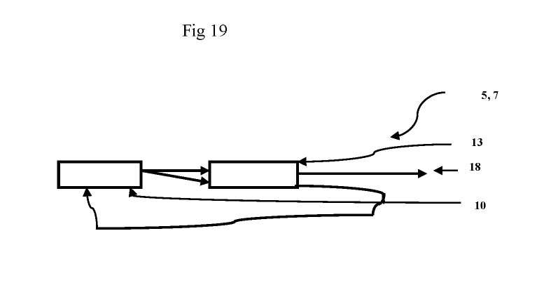

FIG. 19 Wiring diagram of photoelectric sensor.

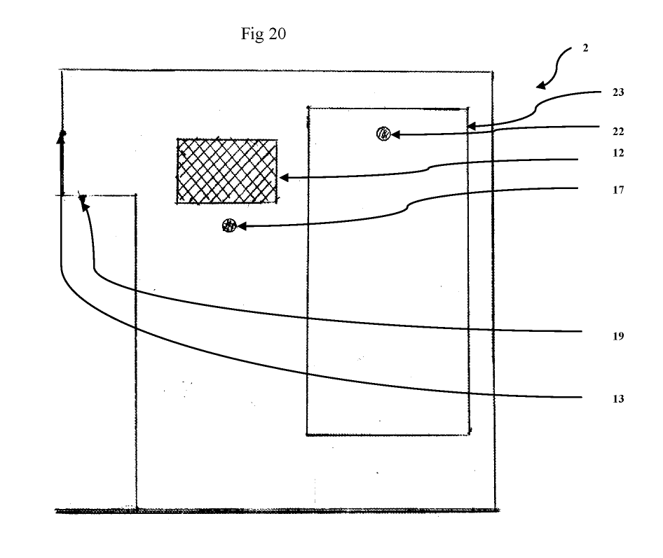

FIG. 20 Alternate configuration (A2) of dispenser with door for reservoir on the long side with the thermostat.

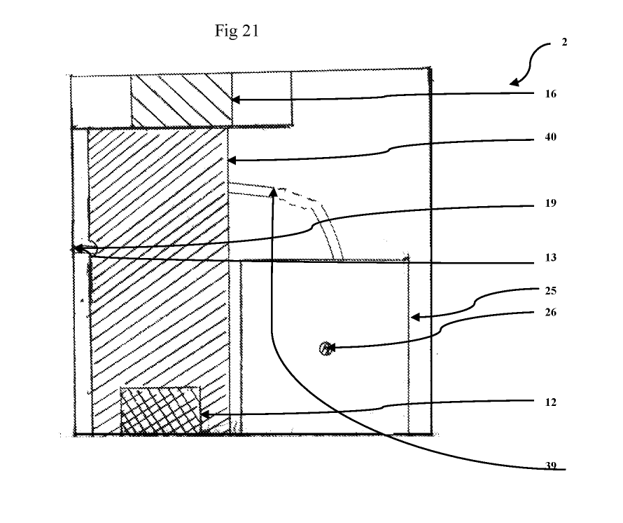

FIG. 21 Internal arrangement of components for alternate configuration A2.

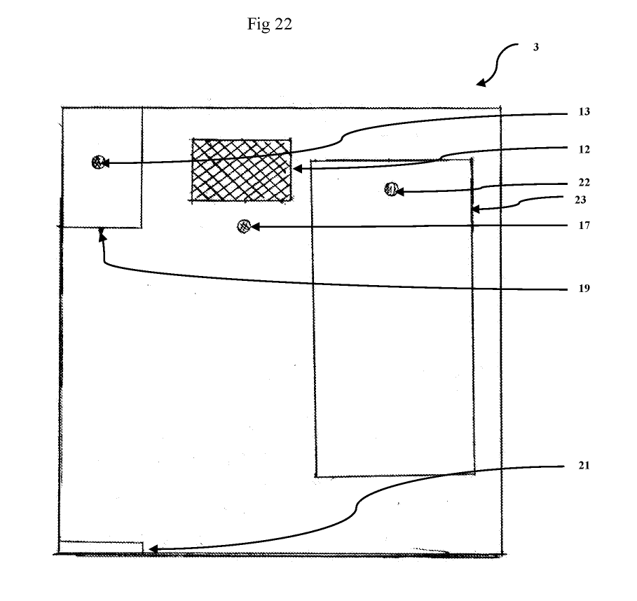

FIG. 22 Alternate configuration (A3) of dispenser with both door for reservoir and spout on the long side with the thermostat.

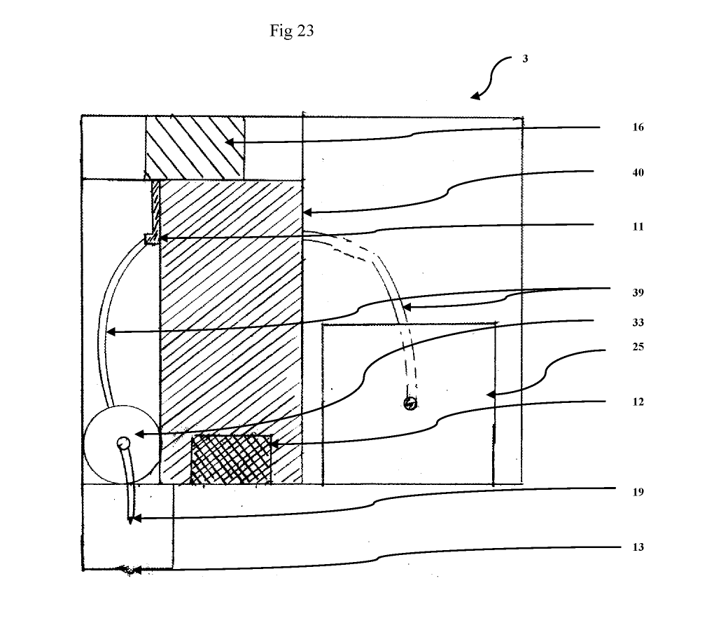

FIG. 23 Internal arrangement of components for alternate configuration A3.

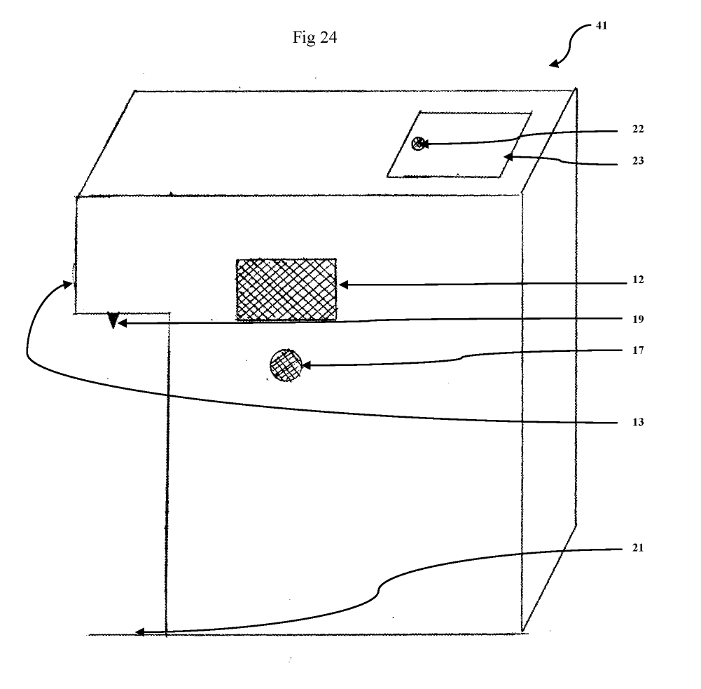

FIG. 24 Alternate configuration (A4) of dispenser with the reservoir permanently installed on the left, a door in the top for adding liquid, and the spout on the long side with the thermostat.

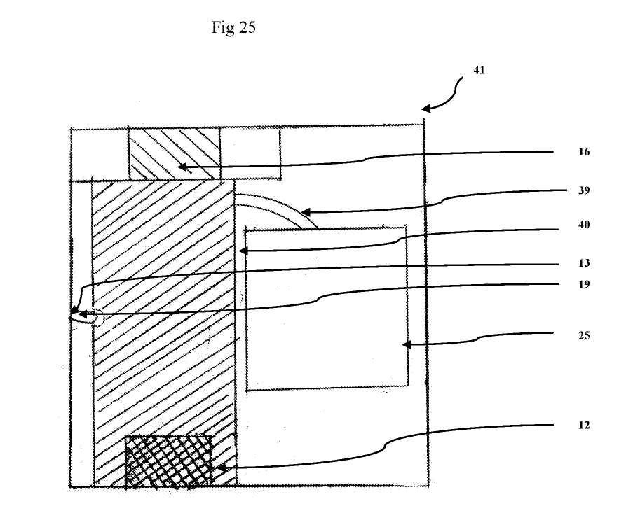

FIG. 25 Possible internal arrangement of components for alternate configuration A4.

### DETAILED DESCRIPTION OF THE INVENTION

The following description of the device is merely illustrative in nature and is in no way intended to limit the invention, its application, or its uses. Furthermore, the cross-hatching and other drawing devices are merely illustrative in nature and are not intended to emphasize a particular part or portion and are not intended to designate a particular material for a particular part or portion.

The figures show several illustrative configurations of a water dispensing device designed for personal use. The first configuration has its external and internal structures sketched in detail (FIGS. 1-19). The other three configurations are illustrated only to indicate the differences from the first configuration. Following is a table of the various numbered components and the figures where they appear.

DESCRIPTIVE KEY

| | FIGURES WHERE | |
|---|---|---|
| Indicator | INDICATION | |
| Number | APPEARS | DESCRIPTION |
| 1 | 1-4, 7, 8, | A view of the first configuration of the dispenser. |
| | 13-16 | |
| 2 | 20-21 | A view of configuration A2 of the dispenser. |
| 3 | 22-23 | A view of configuration A3 of the dispenser. |
| 4 | 10-15 | Water flow in the dispenser. |
| 5 | 17-19 | Electrical flow in the dispenser. |
| 6 | 18 | Thermostat diagram. |
| 7 | 19 | Photoelectric sensor diagram. |
| 8 | 17 | Circuit controlling water pump. |
| 9 | 17 | Circuit controlling cooling fan. |
| 10 | 4, 17, 18, 19 | Battery or ACDC Converter (Electrical input). |
| 11 | 11, 12, 13, 14, 15, 17, 23 | Pump. |
| 12 | 3, 14, 17, 18, 20, 21, 22, 23, 24, 25 | Thermostat (Temperature controller). |
| 13 | 1, 13, 17, 19, 20, 21, 22, 23, 24, 25 | Photoelectric control. |
| 14 | 17 | Fan plus Peltier chip(s) (cooling unit). |
| 15 | 17 | Peltier chip(s). |
| 16 | 2, 4, 13, 16, 17, 21, 23, 25 | Cooling fan. |
| 17 | 3, 14, 17, 20, 22, 24 | On/off switch. |
| 18 | 18, 19 | Controller feed to circuit. |
| 19 | 1, 11, 13, 14, 20, 21, 22, 23, 24, 25 | Spout. |
| 20 | 1, 3, 4, 11 | Receptacle. |
| 21 | 1, 3, 4, 22, 24 | Splash Tray. |
| 22 | 2, 20, 22, 24 | Button to open door. |
| 23 | 2, 7, 8, 20, 22, 24 | Door through which to insert reservoir. |
| 24 | 5, 7, 8, 12, 13, 16 | Cage to contain water reservoir. |
| 25 | 6, 8, 10, 14, 15, 23, 25 | Water reservoir. |
| 26 | 6, 7, 9, 12, 13, 21 | Kent shut-off valve. |
| 27 | 7, 8 | Interior of device. |
| 28 | 9, 10, 16 | Male connector of Kent valve. |
| 29 | 9, 10 | Female connector of Kent valve. |
| 30 | 10, 11 | Water flow diagram. |
| 31 | 10, 11 | Continuation of flow. |
| 32 | 11 | External wall of the dispenser behind spout. |
| 33 | 11, 12, 13.14, 15, 16, 23 | Water filter. |
| 34 | 12, 13 | Internal wall to stabilize the fan. |
| 35 | 12 | Input port of pump. |
| 36 | 12 | Direction of flow indicator. |
| 37 | 12 | Output port of pump. |
| 38 | 12 | Clamp to hold hose to base. |
| 39 | 10, 11, 12, 13, 14, 15, 21, 23, 25 | Tubing. |
| 40 | 13, 15, 16, 21, 23, 25 | Platform for electrical wiring system. |
| 41 | 24, 25 | A view of configuration A4 of the dispenser. |
| 42 | 17 | Indicator light in pump circuit - on when pump is |
| | | running and water is flowing |

### DETAILED DESCRIPTION OF THE INVENTION

This invention is a personal water dispenser, one that can be used by a single individual in an environment such as a dorm or hospital room. Four configurations are shown: however, the invention is not limited to just those configurations but includes any and all configurations implementing the central ideas. The figures indicate possible various external and internal arrangements of the components. The invention as described herein is based on an existing prototype but is not restricted by that example. The figures are herein described based on the order of the figure and the number of the identifying indicator number. The first four figures are of the external sides of the first configuration of the dispenser (A1). The next few indicate the way the water is injected into the system using a removable reservoir, how it is held in place, and how the water is moved through the device. Then three figures depict the wiring scheme for the dispenser and its electrical components. The final six figures show three other possibilities for arranging the components of the dispenser.

FIG. 1 In this figure, 1 indicates the first configuration of the device, A1. This figure depicts the end (short side) of the dispenser showing the photoelectric control 13, which toggles the pump on or off, controlling the water flow through the spout 19. Also shown in this figure is a receptacle for the water 20, not part of the invention, and a splash tray 21 to catch small spills.

FIG. 2 This shows the opposite end of the dispenser 1 with the door 23 for input of the reservoir containing water. The cooling fan 16 is seen on the side of the dispenser in this view and the button 22 to release the door latch is also indicated.

FIG. 3 This figure shows the dispenser 1 long side that holds an on/off switch 17 and thermostat 12 for controlling the temperature of the dispenser and, consequently, of the water to be dispensed. The receptacle 20 and splash tray 21 are also positioned in this figure.

FIG. 4 This figure shows the fourth side of this configuration 1 with the external view of the cooling fan 16. The receptacle 20 and splash tray 21 can again be seen in this figure. In addition, the external location of the electrical input 10 is indicated.

FIG. 5 This is a view of a cage 24 to hold the water reservoir (not shown), which is a removable jar or bottle fitted with a Kent female connector¹. 1 Kent shut-off valve is U.S. Pat. No. 6,082,399.

FIG. 6 This figure is a view of such a reservoir 25 with the Kent shut-off valve 26 indicated.

FIG. 7 Continuing with this part of the device, this figure shows the exterior of the device 1 with the cage 24 as it is located attached to the door 23, with indications of the location of the Kent valve connector 26 and the interior of the device 27.

FIG. 8 This figure portrays the reservoir 25 inside the cage as it would be during operation of the device. This figure again indicates the exterior of the device 1 with the cage 24 as it is located attached to the door 23 and the interior of the device 27.

FIG. 9 The Kent valve is quite complicated internally. This figure gives an external view of the Kent valve 26 indicating the male 28 and female parts 29 which connect to make a secure, leak-proof way of sending water into the dispenser.

FIG. 10 Here the figure indicates the start of the water flow 4, 30 from the reservoir 25 through the female part of the Kent valve 29, into the male Kent connector 28, and then through plastic tubing 39. The flow is continued as shown in FIG. 11 31.

FIG. 11 This indicates the continuation of the water flow 4, 31 from FIG. 10 30 with the tubing 39 leading into the pump 11, then through more tubing 39 to the water filter 33 through more tubing 39 past the external wall of the dispenser 32 to the spout 19 and then into the receptacle 20.

FIG. 12 The exhibits for the water flow 4 are continued here by indicating how the components fit into the inside of the device from a top-down viewpoint. At the bottom of this drawing is the cage 24 where the water reservoir sits. The water goes through the Kent valve 26 sealed with plumber's tape and silicon to plastic tubing 39 flexible and long enough to allow for the opening and closing of the door, under a clamp 38 to secure the tubing to the floor of the device so it stays securely fastened to the input side 35 of the pump 11. The arrow 36 indicates water flow direction from there to the output side 37 of the pump. The water then goes through more tubing 39 to a water filter 33 and will then be sent to the spout (not shown). Other features indicated in this drawing are the internal wall 34 for stabilizing the fan (not shown). If necessary due to the size of the pump 11, the wall 34 may be breached to slide the pump 11 under the fan as is indicated in the drawing.

FIG. 13 This figure shows the same features as FIG. 12 for the water flow 4 by indicating how the components fit into the inside of the device from the viewpoint of a side with the spout 19 on the left and the reservoir cage 24 on the right. This view assumes the first configuration 1. The other configurations vary in detail from this one; however, they all contain the same internal elements. Indicated in this drawing are the locations of the following. The right side of the drawing is the input side where the cage with the reservoir 24 is located. From there the water flow goes through the Kent valve 26 via tubing 39 into the pump 11, through more tubing 39 into the water filter 33 and more tubing 39, ending at the spout 19. Other features shown in this drawing are the photoelectric sensor 13 on the left above the spout 19, the internal stabilizing wall 34 containing the fan 16 and the platform which holds the wiring away from the rest of the apparatus 40.

FIG. 14 This figure shows the same features for the water flow 4 as FIG. 13 but from the opposite side with the spout 19 on the right and the reservoir cage 24 on the left. This view also assumes the first configuration 1. From left to right in this drawing are the water reservoir 25, tubing 39 leading to the pump 11, the water filter 33 and then to the spout 19. Other features indicated are the on-off switch 17 and the thermostat 12.

FIG. 15 This figure shows the water-related components 4 from the same side as FIG. 13, that is, for configuration 1 with the spout (not shown) on the left and the reservoir 25 on the right and indicating the location of the pump 11, the water filter 33, the platform 40 and various plastic tubes 39.

FIG. 16 This shows the view from the top of configuration A1 1 and indicates the locations of the following: the water filter 33, the cooling fan 16, the wiring platform 40, and the cage 24 with the male part of the Kent valve 28.

FIG. 17 This figure is the wiring diagram of the dispenser 5. It indicates the power source 10 for two independent circuits: one for the control of the pump 11 and, thus the water flow 8 and the other for the control of the fan and cooling mechanism 9. The water flow is turned on and off by the photoelectric sensor 13. This is a toggle so if one's hand is waved in front of it when it is off, it turns on, starting the pump 11 and thus the water flow along with the indicator light 41. It is toggled off when the hand is waved again, turning the pump 11 and flow off. Similarly, the cooling mechanism 14 is turned on or off with a switch 17 and also is controlled by a thermostat 12. These control the electrical flow to the Peltier chip or chips 15 attached to a fan 16 which together are used to cool the device to the temperature selected on the thermostat 12.

FIG. 18 This figure is a detail of the wiring system 5 showing the connections to the thermostat 6. Here, the thermostat 12 is connected into the main cooling circuit 18 in order to receive power from the electrical source 10. The thermostat then, through its internal mechanism, modifies the cooling circuit by turning the fan on when the temperature is above a set limit and off when that limit is reached. The continuation to the rest of the cooling circuit 18 is indicated.

FIG. 19 This is similar to FIG. 18 in that it shows a detail of the wiring system 5 but shows the connections for the photoelectric sensor 7. This is connected in the same way as the thermostat shown in FIG. 18. The power source 10 connects the photoelectric control 13 directly in order to make it work. The control then acts as the switch for the rest of the circuit 18.

FIG. 20 This figure indicates alternate configuration A2 2 with the possible arrangement of the door 23 on the long side of the dispenser next to the thermostat 12. Indicated here are the button 22 to latch or unlatch the door 23, the on/off switch 17, and the position of the photoelectric sensor 13 above the spout 19 on the left end of the device.

FIG. 21 This shows how the internal parts of the device would be arranged for configuration A2 2 from a top-down view. Indicated are the positions of the fan 16, the thermostat 12, the platform for the electrical breadbox 40, the location where the tubing for the spout 19 and the wire for the photoelectric sensor 13 exit the main compartment, some plastic tubing 39, and the reservoir 25 with the Kent valve 26.

FIG. 22 This figure indicates alternate configuration A3 3 with the possible arrangement of the photoelectric sensor 13 and the spout 19 and splash tray 21 on the same side as the on/off switch 17, the thermostat 12 and the door 23 with its latch button 22.

FIG. 23 This figure relates to the previous one for configuration A3 3 by showing the suggested internal arrangement of several of the components of the device. The view is from the top of the device with the fan 16 at the top and the electrical platform 40 covering the pump 11 and ending under the thermostat 12. Also indicated are locations for the water reservoir 25, the water filter 33, the spout 19, the photoelectric sensor 13 and some of the tubing 39.

FIG. 24 This figure indicates alternate configuration A4 41 with the possible arrangement of the photoelectric sensor 13 and the spout 19 and splash tray 21 on the same side as the on/off switch 17, the thermostat 12 and the door 23 on the top with its latch button 22. This reservoir would not be removable but would be filled through the door.

FIG. 25 This figure relates to the previous one for configuration A4 41 by showing the suggested internal arrangement of several of the components of the device. The view is from the top of the device with the fan 16 at the top and the electrical platform 40 covering the pump 11 (not shown) and ending under the thermostat 12. Also indicated are locations for the water reservoir 25, the spout 19, the photoelectric sensor 13, and some of the tubing 39. Note that this configuration would not include the Kent valve but would have tubing permanently in position.

The foregoing descriptions of specific embodiments of the present invention have been presented for purposes of illustration and description. They are not intended to be exhaustive or to limit the method of use or implementation to the precise forms shown herein. Obviously many modifications and variations are possible after reading this document. The embodiments were chosen and described in order to demonstrate the feasibility of the invention, to explain its ideas, and to enable others to implement the invention. It is understood that various omissions or substitutions of equivalents are contemplated as circumstances dictate. This patent is intended to cover any application or implementation without departing from the spirit or scope of the claims of the invention described herein. The dispensing of an alternate liquid with or without the presence of a filter is also contemplated and covered by this invention.

What is claimed is:

1. A dispenser for water or another clear liquid of a size and construction for the convenience of a single user comprising:
an insulated shell defining a rectangular prism with external features including an on/off switch, a thermostat, a cooling fan attached to one or more Peltier chips, a door for inserting the liquid, a photoelectric sensor to initiate or stop the flow of the liquid, and a spout through which the liquid emanates;
a removable reservoir containing the liquid to be dispensed;
interior features including stabilizing walls, a Peltier cooling system including at least one thermoelectric chip and a fan, a Kent valve for connecting the reservoir to tubing leading to a pump and, optionally, a filter, and an exit to the spout;
a power source which may be an ac/dc 12 volt converter or a 12 volt battery.

2. Various configurations of the above described beverage dispenser, including one in which the reservoir is fixed.
